(19) United States
(12) Patent Application Publication
(10) Pub. No.: US 2022/0058341 A1
(43) Pub. Date: Feb. 24, 2022

(54) SEMANTIC LANGUAGE FEATURE DEFINITION LANGUAGE FOR USE IN FRAUD DETECTION

(71) Applicant: International Business Machines Corporation, Armonk, NY (US)

(72) Inventors: Russell Gregory Lambert, Wake Forest, NC (US); Eugene Irving Kelton, Wake Forest, NC (US); Jacob McPherson, Franklinton, NC (US); Willie Robert Patten, JR., Hurdle Mills, NC (US)

(21) Appl. No.: 16/998,277

(22) Filed: Aug. 20, 2020

(51) Int. Cl. G06F 40/30; G06F 40/211; G06N 20/00; G06F 16/242

(52) U.S. Cl. CPC G06F 40/30; G06F 16/244; G06N 20/00; G06F 40/211

(57) ABSTRACT

A semantic, machine readable language part that supports the specification of features is used by an engine that interprets that language to produce the features based on the raw data. In this way, the model developer can specify the measurement columns (for example, data fields), to obtain the dimensions from which the engine can compute the multiple combinations of features possible based on this set of input fields. This computation of features can be used to perform machine learning (ML) training and/or scoring algorithms (for example, ML algorithms for fraud detection).

### BACKGROUND

The present invention relates generally to the field of machine learning, and also to the field of computerized fraud detection.

The Wikipedia entry for “feature extraction” (as of 21 Mar. 2020) states, in part, as follows: “In machine learning, pattern recognition and in image processing, feature extraction starts from an initial set of measured data and builds derived values (features) intended to be informative and non-redundant, facilitating the subsequent learning and generalization steps, and in some cases leading to better human interpretations. Feature extraction is related to dimensionality reduction. When the input data to an algorithm is too large to be processed and it is suspected to be redundant (e.g. the same measurement in both feet and meters, or the repetitiveness of images presented as pixels), then it can be transformed into a reduced set of features (also named a feature vector). Determining a subset of the initial features is called feature selection. The selected features are expected to contain the relevant information from the input data, so that the desired task can be performed by using this reduced representation instead of the complete initial data. . . . Feature extraction involves reducing the number of resources required to describe a large set of data. When performing analysis of complex data one of the major problems stems from the number of variables involved. Analysis with a large number of variables generally requires a large amount of memory and computation power, also it may cause a classification algorithm to overfit to training samples and generalize poorly to new samples. Feature extraction is a general term for methods of constructing combinations of the variables to get around these problems while still describing the data with sufficient accuracy. Many machine learning practitioners believe that properly optimized feature extraction is the key to effective model construction.” (footnotes omitted)

### SUMMARY

According to an aspect of the present invention, there is a method, computer program product and/or system that performs the following operations (not necessarily in the following order): (i) receiving a piece of coded syntax including machine readable information indicative of at least the following: (a) an identification of document(s) making up an input corpus, (b) an identification of a set of focal object(s), (c) an identification of a set of measurement(s), (d) an identification of a set of dimension(s), and (e) an identification of set of feature(s) to compute; and (ii) parsing the piece of coded syntax to: (a) retrieve the input corpus, and (b) analyze the corpus with respect to the set of focal object(s), the set of measurement(s) to determine a set of feature value(s) corresponding to the set of feature(s) to compute.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a screenshot view generated by the first embodiment system.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

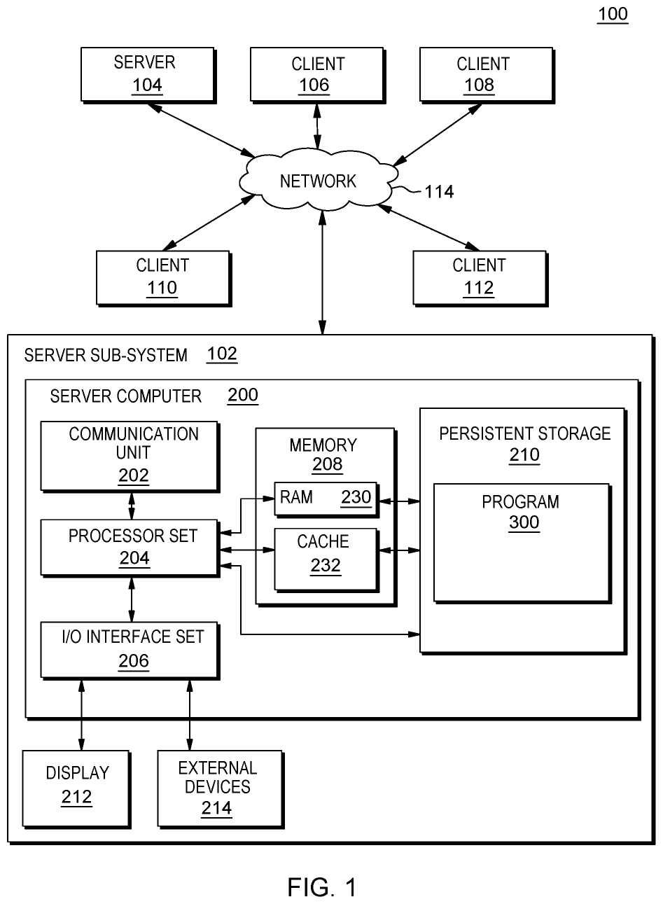

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

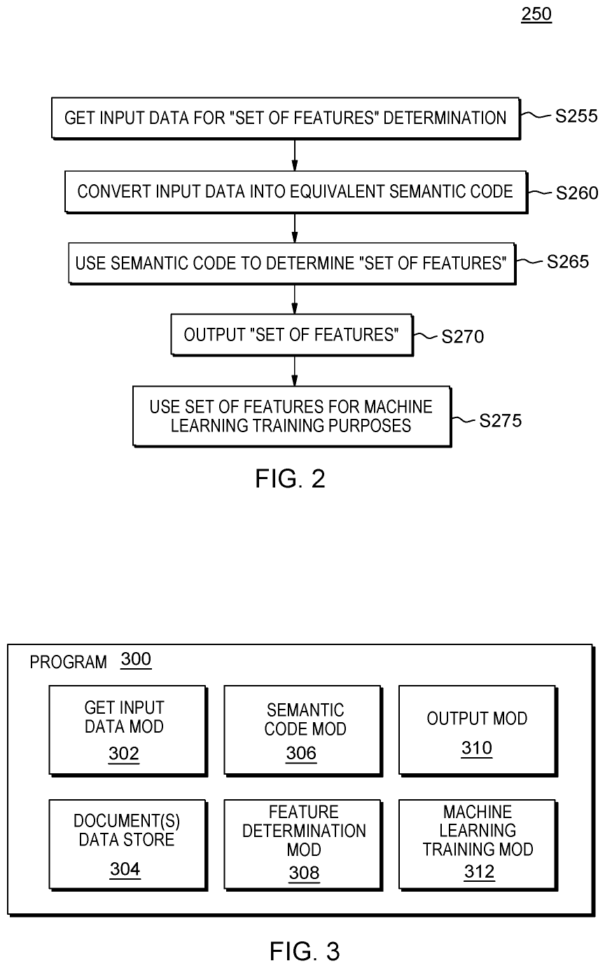

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Before discussing the operations of the method of flowchart 250, a comment will be made about structured and/or unstructured data in the input corpus. In many preferred embodiments of the present invention, the input corpus will be a table of records where each row of the table is a record and each cell of the table in that row is a field value for a field associated with the record. The fields are also sometimes referred to as column headings. These structured data embodiments will be discussed in more detail in the following subsection of this Detailed Description section. On the other hand, the method of flowchart 250, which is about to be discussed, deals with a single document input corpus that is the form of unstructured data. This is helpful because it deals with an input document that is likely to be more intuitively understood by the reader, but it should be understood that the unstructured nature of the data means that sophisticated natural language parsing capabilities are required to parse meaningful data from the natural language input. The details of this parsing stage of unstructured data embodiments of the present invention are beyond the scope of this document. In many commercial applications, this natural language parsing may not be sufficiently reliable, feasible and/or cost effective. Still, some embodiments of the present invention, such as the method corresponding to flowchart 250, may involve using unstructured data as part, or all, of the input corpus.

Processing begins at operation S255, where get input module (“mod”) 302 gets the inputs it needs to determine a “set of features” of a set of document(s) (herein sometimes referred to as an “input corpus,” or, more simply, a “corpus”). In this example, this input information comes from a user of client subsystem 104 through communication network 114. In this example, the input data is as follows: (i) the corpus of text to be reviewed (which is stored in document(s) data store 304); (ii) the focal object(s) to be used in determining the “set of features”; (iii) the measurements to be used in determining the set of features; (iv) the dimensions to be used in determining the set of features; and (v) the identity of the features to compute. Each of these types of input will be discussed in the following paragraphs.

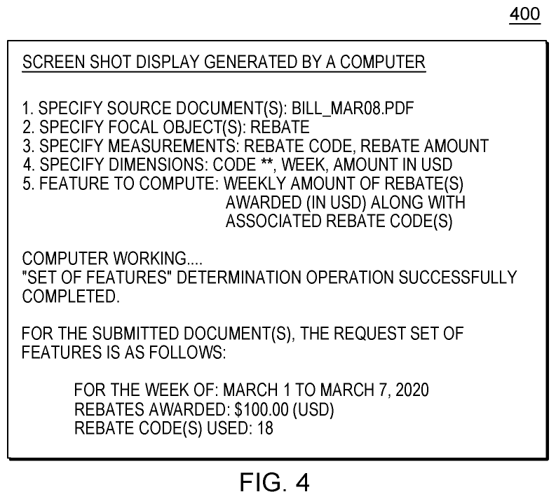

In this example, a user specifies the corpus to be reviewed as shown in item #1 of screenshot 400 of FIG. 4. Alternatively, the identity of the corpus document(s) and/or any of the other input items could be specified by machine logic (for example, software) or by a programmer. In this example, there is only one document in the corpus being reviewed, which, as shown in FIG. 4, has the name “BILL_MAR08.PDF.” Alternatively, there may be many more corpus documents. In this example, the single document consists entirely of unstructured text. As will be discussed in the next sub-section of this Detailed Description section, some embodiments take input in the form of structured information (for example, information that had been entered into a table with well-delineated row and column headings to identify the meaning of the information in each cell of the table). In this example, the text of BILL_MAR08.PDF is as follows:

BILL FOR SERVICES
Date: 08 March 2020
Time: All the clocks read half past eight on this
morn.
Bill covers: svcs rendered 01 March to 06 Mar. 2020
1. 01 March 20: ($500.00) credit for unused services
in month of Feb.
Note: This is the first time the customer has accrued
credit for unused services. It may be good to check
that this customer is satisfied with the services being
provided it.
2. 02Mar20: $1000.00 for disaster recovery related
services, misc. data recovery and associated
migration(s)
Note: This client may not be purchasing sufficient
services, thereby possibly causing a need for these
recovery services; please offer customer a free audit.
3. March 3, 2020: ($0.00): FREE AUDIT
4. 04 Mar 20: $10,000.00 PUBLIC CLOUD STORAGE
SERVICE and ASSOCIATED DATA ANALYTICS
Note customer has purchased additional cloud storage
and analytics service in order to prevent need for
invoking recovery services; the extra private cloud
storage will be secure and it will ensure a sort of
safety margin with respect to data storage needs
05. Mar 5 2020: $5, 000.00 (US): ENHANCED ANALYTICS
EXPANSION MODULE
Note: Customer verbally expressed gratitude for the
high quality and timeliness of timesensitive services,
like data recovery.
06. March 6, 2020: (one hundred dollars) under code
18; PAY FROM TRUST ACCOUNT
Notes: code 18 is the rebate code for making previous
payment as soon as it became due using our
AutoPayProgram
7. 7mar20: − $14,400.00 -- PAYMENT FOR CURRENT
SERVICES PER code 42
Note: 42 is code for the AutoPayProgram

As shown in item #2 of screenshot 400, as far as the focal object(s) input, there is only one focal object specified by the user and it is, as expressed in natural language, “REBATE”. Alternatively, there could be multiple focal objects, depending upon what “set of features” is desired to have determined.

As shown in item #3 of screenshot 400, as far as the measurement(s) input, the measurements used to determine the “set of features” are, expressed in natural language: REBATE CODE and REBATE AMOUNT.

As shown in item #4 of screenshot 400, as far as the dimension(s) input, the dimensions used to determine the “set of features” are, expressed in natural language: (i) CODE ** (which means the two digit code associated with the rebate(s)); (ii) WEEK (that is, the week in which the rebate(s) were given); and (iii) AMOUNT IN USD (which means the amount of the rebates in United States dollars.

As shown in item #5 of screenshot 400, as far as the feature(s)-to-compute input, the features used to determine the “set of features” are, expressed in natural language: “WEEKLY AMOUNT OF REBATE(S) (IN USD) ALONG WITH ASSOCIATED REBATE CODES.”

That concludes the list of four (4) different types of input data used in this example. However, other embodiments may use alternative and/or additional types of input data, such as aggregation attributes input data. This discussion of operation S255 will conclude with a reminder that, while the input data in this example comes from a relatively untrained human user, the input data could come from machine logic (for example, software) or from a programmer who knows the syntax that will be used in the next operation S260.

Processing proceeds to operation S260, where semantic code mod 306 converts the input data previously received at operation S255 into a machine readable code, which is to say a machine readable syntax. This expression of inputs (for example, corpus of text to be reviewed, the focal object(s), the measurement(s), the dimension(s), the aggregation attribute(s) and/or the identity of the features to compute) is an important technological feature of some embodiments of the present invention. The syntax generated for the inputs provided at operation S255 is as follows:

** START OF SYNTAX **
{SOURCE(1) = BILL_MAR08.PDF; SOURCE(>1) = NULL}
{FOCAL_OBJECT(1) = REBATE; FOCAL_OBJECT(>1) = NULL}
{MEASURE(1) = REBATE_CODE; MEASURE(2) = REBATE_AMT);
MEASURE(>2) = NULL}
{AGGREGATION_ATTRIBUTE(>0) = NULL}
{DIMENSION(1) = CODE; DIMENSION(2) = WEEK; DIMENSION(3)
= USD; DIMENSION(>3) = NULL}
{FEATURE_TO_COMPUTE(1) = WEEK/DATES;
FEATURE_TO_COMPUTE(2) = REBATE.AMT/USD;
FEATURE_TO_COMPUTE(3) = REBATE.CODE/TWO_DIGIT;
FEATURE_TO_COMPUTE(>3) = NULL}
** END OF SYNTAX **

The specific syntactical conventions and/or rules inherent in the above sample cope is only an example. Other kinds of code can be used so long as it is formatted and formed consistently enough to be reliably machine readable.

Processing proceeds to operations S265 and S270, where: (i) the machine logic of feature determination mod 308 determines the set of features present in the input corpus using the syntax generated at operation S265; and (ii) output mod 310 outputs the values for the requested set of features to client subsystem 104 (the requestor) through communication network 114 at operation S270. The values corresponding to the requested “set of features” is set forth, in human understandable form and format, at the last three lines of screenshot 400. In this example, the requestor at client subsystem 104 uses the set of features values for auditing and fraud detection purposes. In this particular example, the $100.00 rebate under code 18 is legitimate, so there is no indication of fraud in respect of this rebate.

Processing proceeds to operation S275 where ML training mod 312 uses the set of features values to perform ML training on various machine learning algorithms, such as the software of feature determination mod 308 and/or machine language algorithms used for fraud detection purposes (not shown in the Figures).

### III. Further Comments and/or Embodiments

Some embodiments of the present invention may recognize one, or more, of the following facts, potential problems and/or potential areas for improvement with respect to the current state of the art: (i) For AI/ML (artificial intelligence/machine learning) modeling, it is required that the developer/data scientist convert or create (from the raw data) a set of features that are then used by the models to perform predictions; (ii) this is a manual process that requires a large amount of work before the modeling can be done; (iii) in addition, because this is a manual effort, it is most often done by working with a business analyst who can help determine the features from the data based on the domain knowledge; (iv) whether working alone or with a domain expert the features must be created before they can be used by AI/ML algorithms; (v) thus, if a measurement of CHARGED_VALUE and another of PAID_AMOUNT were going to be analyzed for all transactions from any VENDOR by the dimension of a YEAR, QUARTER, MONTH, WEEK, and DAY, then features would have to be created for all these combinations (by each vendor there would be 2*5=10) combinations that would have to be used in the feature creation; (vi) however, this only provides the ability to do prediction on data based on the features created; (vii) it is common in AI/ML projects for there to be tens of measurement fields and many tens of dimensions; (viii) each combination of measurement and dimension attributes requires the explicit codification to compute the features; and/or (ix) only then can the AI/ML algorithms be coded to make the appropriate prediction.

Some embodiments of the present invention may include one, or more, of the following operations, features, characteristics and/or advantages: (i) a system that includes a semantic language part that supports the specification of features; (ii) a system that includes an engine part that interprets that language to produce the features based on the raw data; (iii) the advantages of this approach allows the model developer to specify the measurement columns (for example, data fields), to obtain the dimensions from which the engine can compute the multiple combinations of features possible based on this set of input fields; and/or (iv) the semantic “language” used by the semantic language part of the system specifies at least some of the following characteristics: (a) focal object, which is the primary rollup attribute (for example, transactions by VENDOR, or by supplier, or by provider, etc.), (b) measurement attribute, which is the attribute field for which to compute the feature (for example, compute the average of the CHARGED_VALUE or the PAID_AMOUNT), (c) aggregations, which are the sub-categories for which to roll up (for example, compute the average of the CHARGED_VALUE (by vendor) by each item CATEGORY (charged value by type of item)), and/or (d) dimensions, which is the time (and other) slices to apply against the data (for example, compute the average by the YEAR, QUARTER, MONTH, WEEK, and DAY).

The semantic language would allow the specification of a combination of properties, for each feature to be computed. That language may be as simple as allowing the specification of: (i) the source file containing the raw data to be used; (ii) the focal objects (the root of all aggregations); (iii) the measurement attributes; (iv) the aggregation attributes; (v) the dimension attributes; and (vi) the set of features to compute. A more specific example will now be set forth in the following code:

[
{
source: {invoices_from_car_dealership.csv,
claims_from_insurance_company.csv}
focalObjects: {vendor, dealership, doctor, junk_yard}
measurements: {CHARGED_VALUE. PAID_AMOUNT,
BILLED_AMOUNT, MSRP, INVOICE_COST}
dimensions: {YEAR, QUARTER, MONTH, WEEK, DAY, AM, PM}
}
{
source: {wire_transactions.csv, atm_usage.csv}
focalObjects: {branch, person, city, target_location}
measurements: {AMOUNT. BALANCE}
dimensions: {ATM, FUND_TYPE}
}
]

In this example under discussion, the engine part of the system would then inspect the data to validate the columns exist, discarding the ones that do not exist on a per source basis. It would then determine the combinations and compute the requested features for each combination. The engine would then use the language specification to determine values for the “set of features.”

A method for providing a semantic language for specification of a combination of properties and a generation engine for applying the specification to data to generate features includes the following operations (not necessarily in the following order): (i) applying the semantic language to an input data wherein the properties include measurement, dimensions, aggregations, and roots of aggregations to form an input for statistical calculation; and (ii) applying statistical calculation to the input for statistical calculations to generate features. In some embodiments, the generated features are passed into a machine learning model. In some embodiments, the machine learning model used is for fraud detection and the input data is related to vendor financial transactions.

Some embodiments of the present invention may include one, or more, of the following operations, features, characteristics and/or advantages: (i) used for the generation of features; (ii) using a specific semantic document to enable the creation of machine learning features; (iii) generation of features based on the content; (iv) about using text to generate features to be used by a machine learning model; (v) generation of a random set of features based on a semantic language defining those features; (vi) a language that allows the definition of how to create a set of features that are then used by machine learning models; (vii) creation of features based on OWL/RDF (web ontology language/resource descriptor framework) type content; (viii) using a specific language to define how to generate a set of features that can then be fed into a machine learning model; (ix) definition of a semantic language that allows the specification of how to generate any type of feature that can then be passed into any type of machine learning model; and/or (x) definition of a language that supports the generation of features, based on any data, that can then be used by machine learning models.

Two simple examples of coded syntax according to the present invention will now be discussed. In both of these examples, a single feature will be generated (that is, one feature for each coded syntax example). If the column checked matches the specified value, then the feature results in a 1 (one); otherwise, it results in a 0 (zero). The first example of coded syntax follows:

{
“transformation”: “flag”,
“label”: “vehicle_style_pickup”,
“flagDataType”: “INTEGER”,
“primary”: {
“column”: “VEHICLE_STYLE”,
“matchCondition”: “==”,
“matchValue”: “PICKUP”
}
},
{
“transformation”: “flag”,
“label”: “vehicle_type_listed”,
“flagDataType”: “INTEGER”,
“primary”: {
“column”: “VEHICLE_TYPE”,
“matchCondition”: “==”,
“matchValue”: “LISTEDONPOLICY”
}
},

The second example of coded syntax follows:

{
“transformation”: “regexMatcher”,
“configurationFile”: {
“termsFile”: {
“source”: {
“fileType”: “csv”,
“name”: “WordDictionary.csv”,
“path”: “file:///opt/ibm/fcii/conf/”
}
},
“table”: “vehicle_incident”,
“aggregate”: true
},
“dataType”: “int”
},

In the second example of coded syntax, the file, WordDictionary.csv includes words and phrases that would be checked. A single feature is created per record in the processed file. A file (WordDictionary.csv) containing words and phrases, such as:

| COLUMN/FEATURE | WORD or PHRASE |
|---|---|
| feature_suspicious | suspicious |
| feature_lower_back | lower back pain |
| feature_abc123 | another word or phrase |

In the investigation table (vehicle_incident), the investigator would take down the description of the accident as given by the claimant. In this example, the corpus includes two pieces of text as follows: (i) “I was sitting at a red light when I was rear-ended and pushed into the intersection where I was struck by another vehicle and am now suffering lower back pain.”; and (ii) “The claimant was acting very suspicious and angry as they were demanding payment immediately.” The result of the application of the second piece of coded syntax to this corpus would be a feature named “feature_lower_back” with a value of 1 for the first line and a value of 0 for the second. Also, another feature named “feature_suspicious” with a value of 1 for the second line and a value of 0 for the first.

A Vehicle Insurance Embodiment of the invention will now be discussed. In the Vehicle insurance embodiment, one of the inputs, and the output are as follows: (i) the input corpus is in the form of an input corpus file (ICF) that includes an input table; and (ii) the identity of features of the input table, generated by the operations of the Vehicle Insurance Embodiment, are in the form of a Created Feature File that includes an output table storing feature values corresponding to the identified features.

The column headings, or fields, of the input table are as follows: (i) CLAIM_TYPE (that is, type of claim); (ii) CLAIM_NUMBER (that is, assigned claim number); (iii) CLAIM_STATE (that is, state accident happened (state claim being filed)); (iv) LOSS_DATE (that is, date of accident); (v) REPORT_DATE (that is, date accident reported); (vi) POLICY_START_DATE (that is, policy start date); (vii) POLICY_RENEWAL_DATE (that is, policy renewal date); (viii) LOSS_DESCRIPTION (that is, investigator notes); (ix) DRIVER_NAME; (x) DRIVER_ADDRESS; (xi) MEDICAL_REQUIRED (that is, medical attention required); (xi) EMT_INVOLVED (that is, whether an emergency medical team was used in the response to the accident); (xii) CLAIM_ESTIMATE; and (xiii) EXPOSURE_ESTIMATE (that is, potential exposure (to insurance company)).

The column headings, or fields, of the output table are as follows: (i) CLAIM_TYPE (these values are taken directly from the input table); (ii) CLAIM_NUMBER (this value is taken directly from the input table and can serve as a set of key values for referencing certain record(s) (or row(s)) of the output table); (iii) HIGH_RISK_STATE (that is, yes or no based on provided list of risky states); (iv) LOSS_DATE_DAYOFWEEK (that is, computed day of week values); (v) REPORT_DATE_DAYOFWEEK (that is, computed day of week values); (vi) DAYS_BTW_LOSS_POLICY_START (that is, days between accident and policy start date); (vii) DAYS_BTW_LOSS_POLICY_END (that is, days between accident and policy end date); (viii) SUSPICIOUS_CLAIM_NOTES (that is, notes taken by investigators indicate suspicion for some reason); and (ix) LARGE_AMOUNT_DIFF (that is, large difference between claim and exposure).

In this Vehicle Insurance Embodiment, one of the records of the output table species that the value of DAYS_BTW_LOSS_POLICY_START for claim number 12345678 is 320. The 320 days elapsed between loss policy start for claim number 12345678 is determined, based on certain values in the input table in the record for customer number 12345678, based on the syntax, and associated machine logic, of an embodiment of the present invention. More specifically, the syntax that was used to extract this part of the extracted 320 value is as follows:

{

“transformation”: “calculation”,
“label”: “days_btw_loss_policy_start”,
“lhs-column”: “LOSS_DATE”,
“operation”: “datediff”,
“rhs-column”: “POLICY_START_DATE”
},

Each syntax for generating feature set(s) according to the present invention will have its own “syntax definition,” which are the rules that apply to interpret the meaning of special characters and/or phrases (some example of this in the Vehicle Insurance Embodiment syntax are the meaning of quotation marks, the meaning of special phrases like “transformation”, the grammar associated with open and close parentheses characters, semi-colons and the like). The syntax definition can be thought of as something akin to a computer language, and code written in this “computer language” are “pieces of syntax,” or, more simply “syntax”).

To continue exploring the Vehicle Insurance Embodiment, assume it is desired to determine a sum of a total by the day of the week, but The input table only provides a date without giving the corresponding day of the week. The Vehicle insurance Embodiment determines the day of the week from that date and only then can aggregate (compute the sum) on a day of the week by day of the week basis. One capability of the Vehicle Insurance Embodiment is to compute those aggregations, but the implementation also supports creating derived indicators that are then used to do that aggregation.

As stated above, in at least some embodiments of the present invention, the following are specified in a piece of syntax written according to a syntax definition: the focal object(s), the measurement(s), the dimension(s) and the aggregation attribute(s). A piece of syntax, in this Vehicle Insurance Embodiment under discussion, which specifies the focal object(s), the measurement(s), the dimension(s) and the aggregation attribute(s), is as follows:

{

“profileName”: “SuspiciousCount”,
“iterators”: {

“crossIterators”: [
{
“tag”: “focalIterator”,
“values”: [

“RESOLVED_IDENTITY”

]

},
{

“tag”: “measureIterator”,
“values”: [

“AMOUNT_PAID”
]

},

{

“tag”: “aggregator1Iterator”,
“values”: [

“CREATE_DATE_DayOfWeek”,
“DIAGNOSIS_ID”
]

}

]

},

In the foregoing piece of syntax: (i) the specified focal is RESOLVED_IDENTITY, (ii) the specified measure is AMOUNT_PAID, and (iii) the aggregation/dimension is CREATE_DATE_DayOfWeek and DIAGNOSIS_ID.

Another piece of syntax used in the Vehicle Insurance Embodiment is as follows:

“stages”: [

{

“focals”: [

“POLICY_ID”,
“CLAIM_ID”
],

},

For the foregoing example piece of syntax: (i) the focals are POLICY_ID and CLAIM_ID; (ii) the LOSS_DATE and the POLICY_START_DATE are the measurements; (iii) the aggregation, or action, in this example is the difference in time between the two measurements; and (iv) in this example there are no dimensions, as just a single output value (or generated feature) that respectively relates to each row of the input table, without being aggregated across multiple rows of the input table, is being determined.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a piece of coded syntax including machine readable information indicative of at least the following: (i) an identification of document(s) making up an input corpus, (ii) an identification of a set of focal object(s), (iii) an identification of a set of measurement(s), (iv) an identification of a set of dimension(s), and (v) an identification of set of feature(s) to compute; and
parsing the piece of coded syntax to:
retrieve the input corpus, and
analyze the corpus with respect to the set of focal object(s), the set of measurement(s) to determine a set of feature value(s) corresponding to the set of feature(s) to compute.

2. The CIM of claim 1 further comprising:
using the set of feature value(s) to perform a scoring function on a machine learning algorithm.

3. The CIM of claim 1 further comprising:
using the set of feature value(s) to perform training for a machine learning algorithm.

4. The CIM of claim 1 wherein:
the piece of coded syntax further includes an identification of a set of aggregation attribute(s); and
the analysis of the corpus to determine the set of feature value(s) is further based on the aggregation attribute(s).

5. The CIM of claim 1 wherein the piece of coded syntax is formed and formatted according to a semantic language part that supports the specification of features.

6. The CIM of claim 1 wherein the input corpus is in OWL/RDF (web ontology language/resource descriptor framework).

7. The CIM of claim 1 wherein the input corpus is made up of unstructured data.

8. The CIM of claim 1 wherein the input corpus is made up of structured data.

9. A computer program product (CPP) comprising:
a set of storage device(s); and
computer code stored collectively in the set of storage device(s), with the computer code including data and instructions to cause a processor(s) set to perform at least the following operations:
receiving a piece of coded syntax including machine readable information indicative of at least the following: (i) an identification of document(s) making up an input corpus, (ii) an identification of a set of focal object(s), (iii) an identification of a set of measurement(s), (iv) an identification of a set of dimension(s), and (v) an identification of set of feature(s) to compute, and
parsing the piece of coded syntax to:
retrieve the input corpus, and
analyze the corpus with respect to the set of focal object(s), the set of measurement(s) to determine a set of feature value(s) corresponding to the set of feature(s) to compute.

10. The CPP of claim 9 wherein the computer code further includes data and instructions for causing the processor(s) set to perform the following operation(s):
using the set of feature value(s) to perform a scoring function on a machine learning algorithm.

11. The CPP of claim 9 wherein the computer code further includes data and instructions for causing the processor(s) set to perform the following operation(s):
using the set of feature value(s) to perform training for a machine learning algorithm.

12. The CPP of claim 9 wherein:
the piece of coded syntax further includes an identification of a set of aggregation attribute(s); and
the analysis of the corpus to determine the set of feature value(s) is further based on the aggregation attribute(s).

13. The CPP of claim 9 wherein the piece of coded syntax is formed and formatted according to a semantic language part that supports the specification of features.

14. The CPP of claim 9 wherein the input corpus is in OWL/RDF (web ontology language/resource descriptor framework).

15. The CPP of claim 9 wherein the input corpus is made up of unstructured data.

16. The CPP of claim 9 wherein the input corpus is made up of structured data.

17. A computer system (CS) comprising:
a processor(s) set;
a set of storage device(s); and
computer code stored collectively in the set of storage device(s), with the computer code including data and instructions to cause the processor(s) set to perform at least the following operations:
receiving a piece of coded syntax including machine readable information indicative of at least the following: (i) an identification of document(s) making up an input corpus, (ii) an identification of a set of focal object(s), (iii) an identification of a set of measurement(s), (iv) an identification of a set of dimension(s), and (v) an identification of set of feature(s) to compute, and
parsing the piece of coded syntax to:
retrieve the input corpus, and
analyze the corpus with respect to the set of focal object(s), the set of measurement(s) to determine a set of feature value(s) corresponding to the set of feature(s) to compute.

18. The CS of claim 17 wherein:
the piece of coded syntax further includes an identification of a set of aggregation attribute(s); and
the analysis of the corpus to determine the set of feature value(s) is further based on the aggregation attribute(s).

19. The CS of claim 17 wherein the piece of coded syntax is formed and formatted according to a semantic language part that supports the specification of features.

20. The CS of claim 17 wherein the input corpus is in OWL/RDF (web ontology language/resource descriptor framework).
